(19) United States
(12) Patent Application Publication
(10) Pub. No.: US 2026/0222818 A1
(43) Pub. Date: Jul. 30, 2026

(54) Seamless Bluetooth Passkey Entry for Scanning/Camera Devices

(71) Applicant: Zebra Technologies Corporation, Lincolnshire, IL (US)

(72) Inventors: Kamal Azoqa, Irvine, CA (US); Mariya Wright, Cortland Manor, NY (US); Nina Feinstein, Hicksville, NY (US)

(73) Assignee: Zebra Technologies Corporation, Lincolnshire, IL (US)

(21) Appl. No.: 19/040,069

(22) Filed: Jan. 29, 2025

(51) Int. Cl. H04W 12/50; G06V 30/19; H04W 12/041; H04W 76/14

(52) U.S. Cl. CPC H04W 12/50; G06V 30/19; H04W 12/041; H04W 76/14

(57) ABSTRACT

Imaging devices, systems, and methods for performing image analysis operations to establish a secure communication connection are described herein. An example device includes: an imaging assembly configured to capture image data including a field of view (FOV); and a computer-readable media storing machine readable instructions that, when executed, cause the imaging device to: (i) capture, using the imaging assembly, first image data of a first indicia of the plurality of payload-encoding indicia; (ii) initiate, responsive to decoding the first indicia of the plurality of payload-encoding indicia, an imaging device connection process; (iii) capture, using the imaging assembly and after initiating the imaging device connection process, second image data of a second indicia of the plurality of payload-encoding indicia; and (iv) generate, based at least on the second indicia of the plurality of payload-encoding indicia, a passkey for performing the imaging device connection process.

### BACKGROUND

Modern scanning systems often include communication capabilities to pair with a separate computing device. In particular, it may be desirable to pair a scanning system with a separate computing device to allow for convenient inventory management, product identification, systems management, etc. As such, scanning systems may adhere to one or more communication protocols for connecting to computing device(s), such as Wi-Fi, Bluetooth, NFC, etc. Connecting computing and imaging devices via such protocol(s), however, may require adherence to various security concerns that may complicate and/or frustrate the overall connection process. As such, an imaging and/or scanning system configured to establish a connection (e.g., a wireless connection, a wired connection, etc.) with a computing device is desirable.

### SUMMARY

In some aspects, the techniques described herein relate to an imaging device, including: an imaging assembly configured to capture image data of a plurality of payload-encoding indicia, the image data including a field of view (FOV); and a computer-readable media storing machine readable instructions that, when executed, cause the imaging device to: capture, using the imaging assembly, first image data of a first indicia of the plurality of payload-encoding indicia; initiate, responsive to decoding the first indicia of the plurality of payload-encoding indicia, an imaging device connection process; capture, using the imaging assembly and after initiating the imaging device connection process, second image data of a second indicia of the plurality of payload-encoding indicia; and generate, based at least on the second indicia of the plurality of payload-encoding indicia, a passkey for performing the imaging device connection process.

In some aspects, the techniques described herein relate to an imaging device, wherein the imaging device connection process is a wireless pairing process to pair the imaging device to a computing device.

In some aspects, the techniques described herein relate to an imaging device, wherein the computer-readable media stores further machine readable instructions that, when executed, cause the imaging device to: transmit the passkey to the computing device; and perform, after transmitting the passkey to the computing device, the imaging device connection process with the computing device.

In some aspects, the techniques described herein relate to an imaging device, wherein initiating the imaging device connection process includes: transmitting an indication to the computing device to cause the computing device to display the second indicia of the plurality of payload-encoding indicia.

In some aspects, the techniques described herein relate to an imaging device, wherein: the indication includes a message to the computing device to cause an application stored on the computing device to initiate a passkey generation process to generate the passkey; and the second indicia is representative of the passkey.

In some aspects, the techniques described herein relate to an imaging device, wherein the passkey includes a randomly generated sequence of alphanumeric characters.

In some aspects, the techniques described herein relate to an imaging device, wherein the plurality of payload-encoding indicia includes at least one of: (i) a one-dimensional (1D) barcode, (ii) a two-dimensional (2D) barcode, or (iii) a 2D data matrix.

In some aspects, the techniques described herein relate to an imaging device, wherein the computer-readable media stores further machine readable instructions that, when executed, cause the imaging device to: start, responsive to initiating the imaging device connection process, a connection timer configured to end the imaging device connection process responsive to expiring.

In some aspects, the techniques described herein relate to an imaging device, wherein the computer-readable media stores further machine readable instructions that, when executed, cause the imaging device to: deactivate, responsive to performing the imaging device connection process, the connection timer.

In some aspects, the techniques described herein relate to an imaging device, wherein starting the connection timer includes: transmitting, responsive to initiating the imaging device connection process, a message to a computing device to cause the computing device to start the connection timer.

In some aspects, the techniques described herein relate to an imaging device, wherein the imaging device connection process is associated with a wireless connection protocol.

In some aspects, the techniques described herein relate to an imaging device, wherein the imaging device connection process enables a connection between the imaging device and a mobile device at a highest level of security for the wireless connection protocol.

In some aspects, the techniques described herein relate to an imaging device, including: an imaging assembly configured to capture image data of a payload-encoding indicia, the image data including a field of view (FOV); and a computer-readable media storing machine readable instructions that, when executed, cause the imaging device to: capture, using the imaging assembly, first image data of the payload-encoding indicia; initiate, responsive to decoding the payload-encoding indicia, an imaging device connection process; capture, using the imaging assembly and after initiating the imaging device connection process, second image data including text representative of a passkey for performing the imaging device connection process; and generate, based at least on the text representative of the passkey and using optical character recognition (OCR), the passkey for performing the imaging device connection process.

In some aspects, the techniques described herein relate to an imaging device, wherein the imaging device connection process is a wireless pairing process to pair the imaging device to a computing device.

In some aspects, the techniques described herein relate to an imaging device, wherein the computer-readable media stores further machine readable instructions that, when executed, cause the imaging device to: transmit the passkey to the computing device; and perform, after transmitting the passkey to the computing device, the imaging device connection process with the computing device.

In some aspects, the techniques described herein relate to an imaging device, wherein initiating the imaging device connection process includes: transmitting an indication to the computing device to cause the computing device to display the text representative of the passkey.

In some aspects, the techniques described herein relate to an imaging device, wherein the text representative of the passkey includes a randomly generated sequence of alphanumeric characters.

In some aspects, the techniques described herein relate to an imaging device, wherein the payload-encoding indicia includes at least one of: (i) a one-dimensional (1D) barcode, (ii) a two-dimensional (2D) barcode, or (iii) a 2D data matrix.

In some aspects, the techniques described herein relate to an imaging device, wherein the computer-readable media stores further machine readable instructions that, when executed, cause the imaging device to: start, responsive to the initiating the imaging device connection process, a connection timer configured to end the imaging device connection process responsive to expiring.

In some aspects, the techniques described herein relate to an imaging device, wherein the computer-readable media stores further machine readable instructions that, when executed, cause the imaging device to: deactivate, responsive to performing the imaging device connection process, the connection timer.

In some aspects, the techniques described herein relate to an imaging device, wherein starting the connection timer includes: transmitting, responsive to initiating the imaging device connection process, a message to a computing device to cause the computing device to start the connection timer.

In some aspects, the techniques described herein relate to an imaging device, wherein the imaging device connection process is associated with a wireless connection protocol.

In some aspects, the techniques described herein relate to an imaging device, wherein the imaging device connection process enables a connection between the imaging device and a mobile device at a highest level of security for the wireless connection protocol.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A illustrates an isometric view of an example bioptic barcode reader;

FIG. 1B illustrates a front perspective view of an example handheld barcode reader as an alternative example imaging device to that of FIG. 1A;

FIG. 1C illustrates a back perspective view of the handheld barcode reader of FIG. 1B;

FIG. 2 illustrates a block diagram of an example imaging device such as the example barcode readers of FIGS. 1A-1C;

FIG. 3A illustrates an exemplary embodiment of a mobile device displaying a decode indicia to be captured and/or decoded by an example imaging device such as the example barcode readers of FIGS. 1A-2;

FIG. 3B illustrates an exemplary embodiment similar to that of FIG. 3A, but in which the mobile device displays a generated passkey to be analyzed via optical character recognition (OCR) techniques by an example imaging device such as the example barcode readers of FIGS. 1A-2;

FIG. 4 illustrates a flow diagram of an example method to establish a secure connection with a computing device via scanning a displayed indicia by an imaging device, such as those depicted in FIGS. 1A-3C; and

FIG. 5 illustrates a flow diagram of an example method to establish a secure connection with a computing device via OCR analysis of a displayed passkey by an imaging device, such as those depicted in FIGS. 1A-3C.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

To connect computing devices via various communication protocols, at least one of the computing devices may generate a passkey that the user inputs into the other computing device with a time limit to establish a secure connection between the devices. Such a secure connection may be necessary to ensure safe and secure payment transfers. However, some imaging devices do not include a user interface, keypad, keyboard, mouse, or any other device for inputting the passkey, and may therefore be difficult to pair properly. For example, such devices may instead input characters by scanning corresponding barcodes, often in a printed manual, each representative of a single digit or character the user tries to input. However, such scanning is difficult to perform quickly and accurately. Without a way to remove characters and with a time limit, frequently of at most 30 seconds, such devices may take multiple attempts to securely establish a connection with a corresponding computing device using such techniques.

The example imaging devices disclosed herein therefore sends a request to a computing device to cause the computing device to generate the passkey for the imaging devices to scan and decode directly. In some implementations, the example imaging device causes the computing device to generate a single payload-encoding indicia representative of the passkey for the imaging device to scan and decode. Upon decoding the payload-encoding indicia, the imaging device generates the complete passkey and transmits an indication of such to the computing device to perform the connection procedure. In further implementations, the imaging device uses optical character recognition (OCR) techniques to analyze the passkey displayed on the computing device and generate a matching passkey with which to perform the connection procedure.

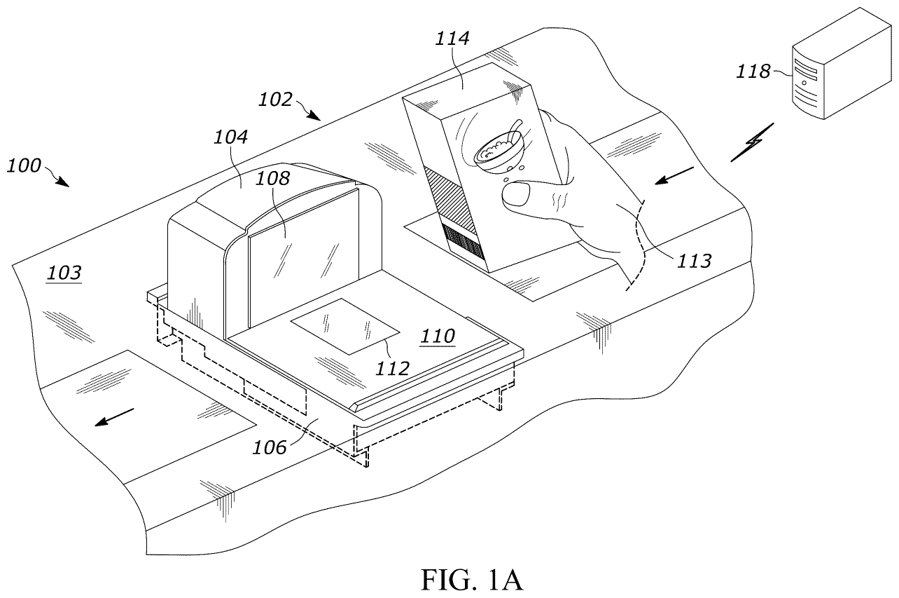

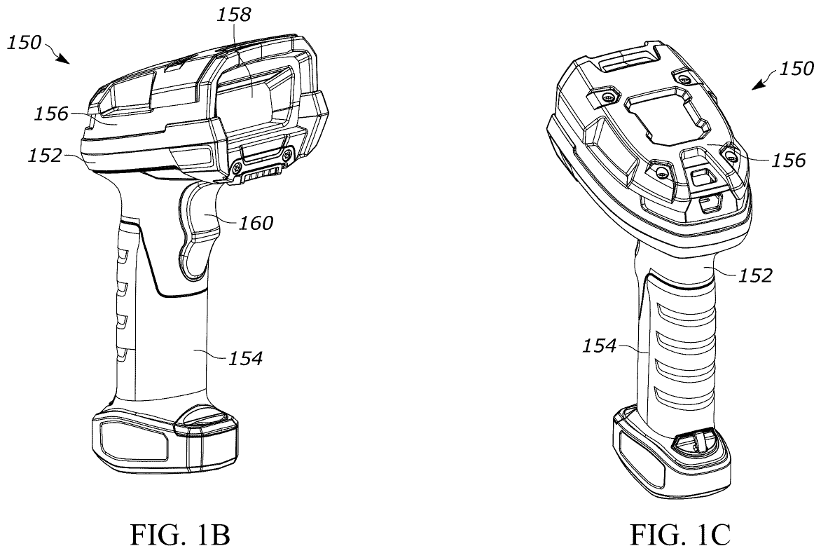

Referring to FIG. 1A, shown therein is an example imaging device embodied in a bi-optic indicia reader 100. In the illustrated example, the bioptic indicia reader 100 is shown as part of a point-of-sale (POS) system arrangement 102 having the bioptic indicia reader 100 positioned within a workstation counter 103. Generally, the indicia reader 100 includes an upper housing 104 (also referred to as an upper portion, upper housing portion, or tower portion) and a lower housing 106 (also referred to as a lower portion, lower housing portion, or platter portion), collectively referred to as a housing. The upper housing 104 can be characterized by an optically transmissive window 108 positioned therein along a generally vertical (or upright) plane and one or more field of view (FOV) which passes through the window 108 and extends in a generally lateral direction. In some examples, a reference to a generally upright window shall be understood to mean a window inclined at an angle of up to 35 degrees relative to a vertical plane. The lower housing 106 can be characterized by a weigh platter 110 or a cover that includes an optically transmissive window 112 positioned therein along a generally horizontal (also referred to as a transverse) plane and one or more FOV which passes through the window 112 and extends in a generally upward direction. In some examples, a reference to a generally horizontal window shall be understood to mean a window inclined at an angle of up to 25 degrees relative to a horizontal plane. The weigh platter 110 is a part of a weigh platter assembly that generally includes the weigh platter 110 and a scale (or load cell) configured to measure the weight of an object placed the top surface of the weight platter 110. By that virtue, the top surface of the weight platter 110 may be considered to be the top surface of the lower housing 106 that faces a product scanning region there above.

In operation, a user 113 generally passes an object 118 across a product scanning region of the indicia reader 100 in a swiping motion in some general direction, which in the illustrated example is right-to-left. A product scanning region can be generally viewed as a region that extends above the platter 110 and/or in front of the window 108 where barcode reader 100 is operable to capture image data of sufficient quality to perform imaging-based operations like decoding a barcode that appears in the obtained image data. It should be appreciated that while items may be swiped past the indicia reader 100 in either direction, items may also be presented into the product scanning region by means other than swiping past the window(s). When the object 118 comes into the any of the fields of view of the reader, the indicia 116 on the object 118 is captured and decoded by the indicia reader 100 (and its respective modules and/or assemblies), and corresponding data (e.g., the payload of the indicia) is transmitted to a communicatively coupled host 114 (commonly comprised of a point of sale (POS) terminal).

Referring next to FIGS. 1B and 1C, illustrated therein is another exemplary imaging device. In particular, handheld imaging device 150 has a housing 152 with a handle portion 154, also referred to as a handle 154, and a head portion 156, also referred to as a scanning head 156. The head portion 156 includes a window 158 and is configured to be positioned on the top of the handle portion 154. The handle portion 154 is configured to be gripped by a reader user and includes a trigger 160 for activation by the user. Optionally included in an embodiment is also a base (not shown), also referred to as a base portion, which may be attached to the handle portion 154 opposite the head portion 156 and is configured to stand on a surface and support the housing 152 in a generally upright position. The handheld imaging device 150 can be used in a hands-free mode as a stationary workstation when it is placed on a countertop or other workstation surface. The handheld imaging device 150 can also be used in a handheld mode when it is picked up off the countertop or base station and held in an operator's hand. In the hands-free mode, products can be slid, swiped past, or presented to the window 158 for the reader to initiate barcode reading operations. In the handheld mode, the handheld imaging device 150 can be moved towards a barcode on a product, and the trigger 160 can be manually depressed to initiate imaging of the barcode.

Other implementations may provide only handheld or only hands-free configurations. In the embodiment of FIGS. 1B and 1C, the handheld imaging device 150 is ergonomically configured for a user's hand, though other configurations may be utilized as understood by those of ordinary skill in the art. As shown, the lower handle portion 154 extends below and rearwardly away from the body housing 152 along a centroidal axis obliquely angled relative to a central FOV axis of a FOV of an imaging assembly within the scanning head portion 156.

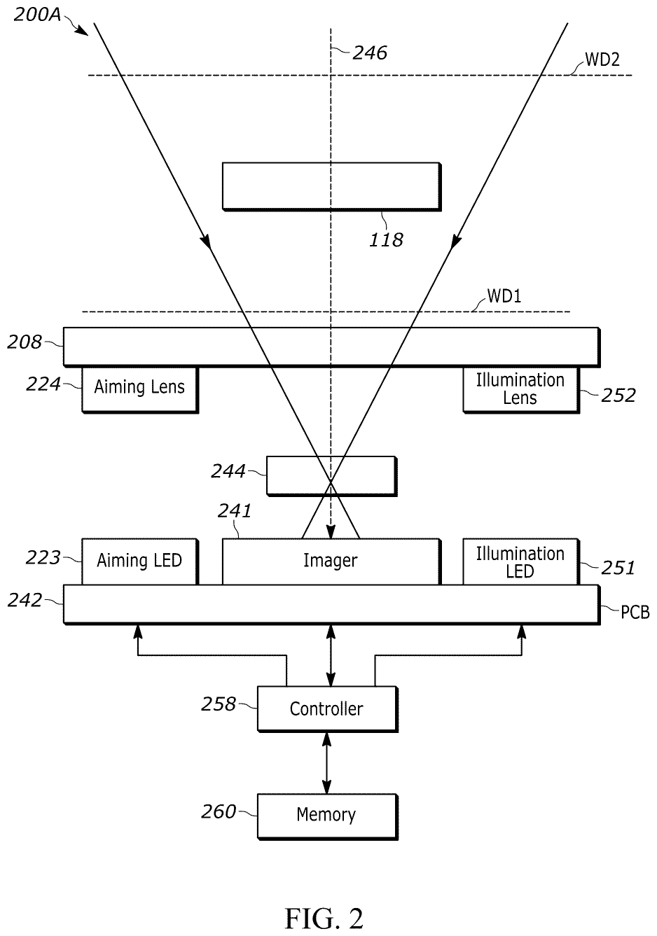

In some embodiments, an imaging assembly includes a light-detecting sensor or imager operatively coupled to, or mounted on, a printed circuit board (PCB) in the handheld imaging device 150 as shown in FIG. 2. In further embodiments, an illuminating light assembly is also mounted in the handheld imaging device 150. The illuminating light assembly may include an illumination light source and at least one illumination lens, configured to generate a substantially uniform distributed illumination pattern of illumination light on and along an object to be read by image capture, as described below with regard to FIG. 2.

Referring next to FIG. 2, a block diagram of an example architecture for an imaging device such as bioptic indicia reader 100 and/or handheld imaging device 150 is shown. For at least some of the reader implementations, an imaging assembly of the imaging device 200 includes a light-detecting sensor or imager 241 operatively coupled to, or mounted on, a printed circuit board (PCB) 242 in the imaging device 200 as shown in FIG. 2. In an implementation, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imager 241 over a field of view along an imaging axis 246 through the window 208. The imager 241 may also include and/or function as a monochrome sensor and, in further implementations, a color sensor. It should be understood that the terms “imager”, “image sensor”, and “imaging sensor” are used interchangeably herein. Depending on the implementation, imager 241 may include a color sensor such as a vision camera in addition to and/or as an alternative to the monochrome sensor. In some implementations, the imager 241 is or includes a barcode reading module (e.g., a monochromatic imaging sensor). In further implementations, the imager 241 additionally or alternatively is or includes a vision camera (e.g., a color imaging sensor). It will be understood that, although imager 241 is depicted in FIG. 2 as a single block, that imager 241 may be multiple sensors spread out in different locations of imaging device 200.

The return light is scattered and/or reflected from an object 118 over the field of view. The imaging lens 244 is operative for focusing the return light onto the array of image sensors to enable the object 118 to be imaged. In particular, the light that impinges on the pixels is sensed and the output of those pixels produce image data that is associated with the environment that appears within the FOV (which can include the object 118). This image data is typically processed by a controller (usually by being sent to a decoder) which identifies and decodes decodable indicia captured in the image data. Once the decode is performed successfully, the reader can signal a successful “read” of the object 118 (e.g., a barcode). The object 118 may be located anywhere in a working range of distances between a close-in working distance (WD1) and a far-out working distance (WD2). In an implementation, WD1 is about one-half inch from the window 208, and WD2 is about thirty inches from the window 208.

An illuminating light assembly may also be mounted in, attached to, or associated with the imaging device 200. The illuminating light assembly includes an illumination light source 251, such as at least one light emitting diode (LED) and at least one illumination lens 252, and preferably a plurality of illumination and illumination lenses, configured to generate a substantially uniform distributed illumination pattern of illumination light on and along the object 118 to be imaged by image capture. Although FIG. 2 illustrates a single illumination light source 251, it will be understood that the illumination light source 251 may include more light sources. At least part of the scattered and/or reflected return light is derived from the illumination pattern of light on and along the object 118.

An aiming light assembly may also be mounted in, attached to, or associated with the imaging device 200 and preferably includes an aiming light source 223, e.g., one or more aiming LEDs or laser light sources, and an aiming lens 224 for generating and directing a visible aiming light beam away from the imaging device 200 onto the object 118 in the direction of the FOV of the imager 241. It will be understood that, although the aiming light assembly and the illumination light assembly both provide light, an aiming light assembly differs from the illumination light assembly at least in the type of light the component provides. For example, the illumination light assembly provides diffuse light to sufficiently illuminate an object 118 and/or an indicia of the object 118 (e.g., for image capture). An aiming light assembly instead provides a defined illumination pattern (e.g., to assist a user in visualizing some portion of the FOV). Similarly, in some implementations, the illumination light source 251 and the aiming light source 223 are active at different, non-overlapping times. For example, the illumination light source 251 may be active on frames when image data is being captured and the aiming light source 223 may be active on frames when image data is not being captured (e.g., to avoid interference with the content of the image data).

In further implementations, the imaging device 200 may additionally emit an auditory cue, such as a chime, beep, message, etc. In still further implementations, the imaging device 200 may provide haptic feedback to a user, such as vibration (e.g., a single vibration, vibrating in a predetermined pattern, vibrating synchronized with flashing, etc.).

Further, the imager 241, the illumination source 251, and the aiming source 223 are operatively connected to a controller or programmed controller 258 (e.g., a microprocessor facilitating operations of the other components of imaging device 200) operative for controlling the operation of these components. In some implementations, the controller 258 functions as or is communicatively coupled to a vision application processor for receiving, processing, and/or analyzing the image data captured by the imager 241.

A memory 260 is connected and accessible to the controller 258. Preferably, the controller 258 is the same as the one used for processing the captured return light from the illuminated object 118 to obtain data related to the object 118. Though not shown, additional optical elements, such as collimators, lenses, apertures, compartment walls, etc. may be provided in the housing (e.g., as described above with regard to FIGS. 1A-1C). Although FIG. 2 shows the imager 241, the illumination source 251, and the aiming source 223 as being mounted on the same PCB 242, it should be understood that different implementations of the imaging device 200 may have these components each on a separate PCB, or in different combinations on separate PCBs. For example, in an implementation of the imaging device 200, the illumination LED source is provided as an off-axis illumination (i.e., has a central illumination axis that is not co-axial with the central FOV axis).

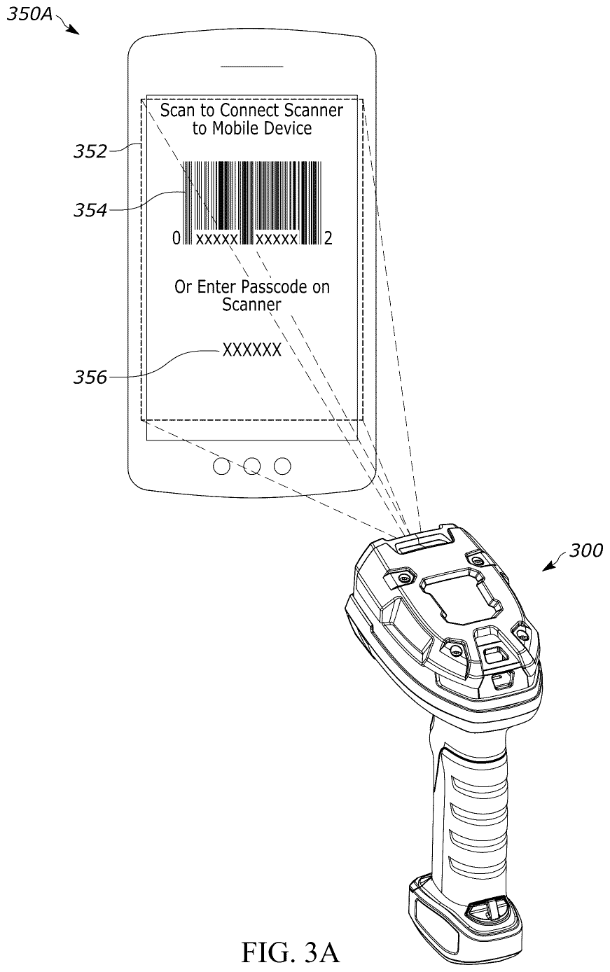

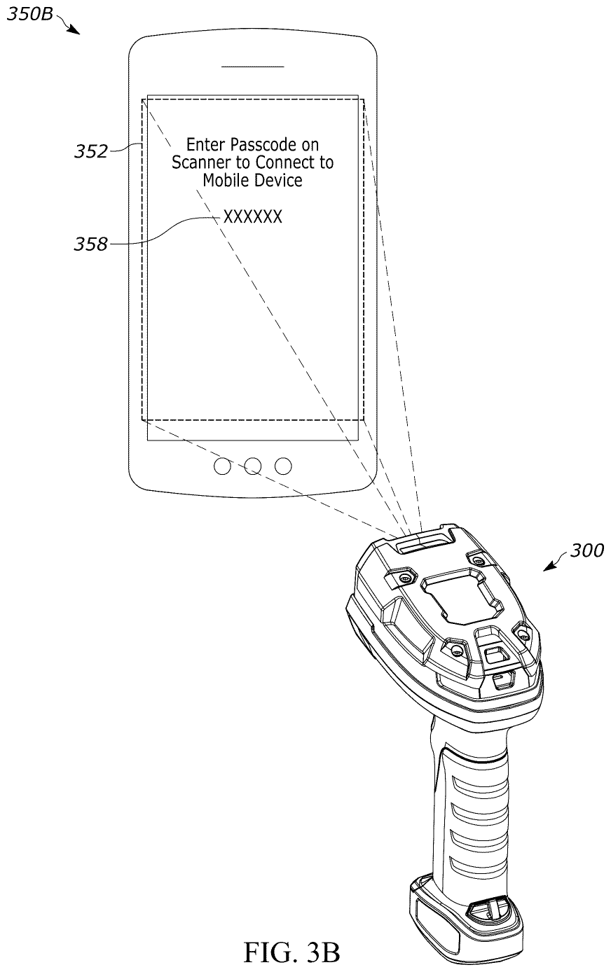

In the example of FIGS. 3A and 3B, the imaging device 300 (e.g., similar to or including elements of bioptic indicia reader 100, handheld imaging device 150, imaging device 200, etc.) captures an image of mobile device 350A and mobile device 350B, respectively (referred to commonly as “mobile device 350” or “mobile devices 350”) in the field of view (FOV) 352 for the imaging device 300. It will be understood that, although FIGS. 3A and 3B depict a mobile device 350, any similar computing device as described herein may be utilized (e.g., the mobile device 350, a personal computer with a display, a terminal with a display, etc.).

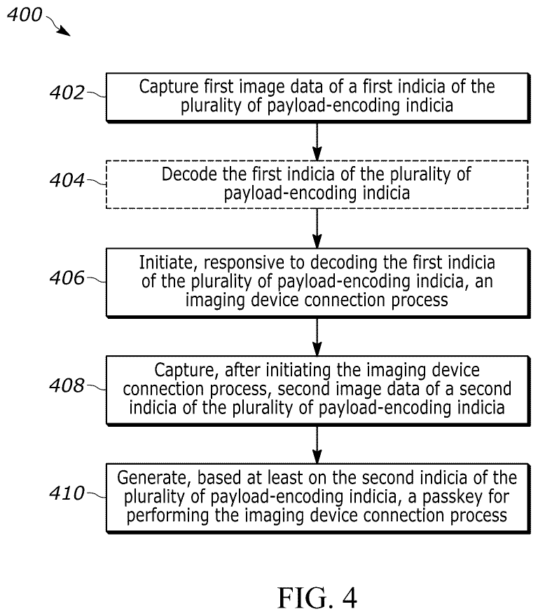

In the exemplary embodiment of FIG. 3A, the mobile device 350A displays a payload-encoding indicia 354 and a text passcode 356. Depending on the implementation, the imaging device 300 may capture an image of the mobile device 350A and decode the payload-encoding indicia 354. The payload-encoding indicia may be representative of the passcode 356 and may be randomly generated as described below with regard to FIG. 4. Alternatively, in implementations in which the imaging device 300 has an interface for inputting characters and/or is communicatively coupled to a computing device for inputting characters, a user may manually input the passcode 356.

In the exemplary embodiment of FIG. 3B, the mobile device 350B displays only the passcode and not the payload-encoding indicia. In further implementations, the mobile device(s) 350 may alternatively display only the payload-encoding indicia. In implementations in which the mobile device 350 displays the payload-encoding indicia, the imaging device 300 may capture an image of the payload-encoding indicia and decode the payload-encoding indicia to generate the passkey. In further implementations in which the imaging device 300 displays the passkey, the imaging device 300 may capture an image of the passkey and perform an OCR operation to generate the passkey. In implementations in which the mobile device 350 displays both the payload-encoding indicia and the passkey, the imaging device 300 may attempt to perform one procedure and perform the other procedure if the initial attempt fails or reaches a timeout point.

Referring next to FIG. 4, the method 400 illustrates a flow diagram of an example method for capturing an indicia (e.g., the indicia 352 of FIG. 3A) and, based on the indicia, generating a passkey for connecting an imaging device (e.g., imaging device 300) to a mobile device (e.g., the mobile device 350 of FIG. 3A). Although the method 400 is described below with regard to imaging device 300 of FIG. 3A, it will be understood that other similarly suitable imaging devices and/or components may be used instead (e.g., bioptic indicia reader 100, handheld imaging device 150, imaging device 200, etc.).

At block 402, the imaging device 300 captures first image data of a first indicia. In some implementations, the first indicia may be a first indicia of a plurality of payload-encoding indicia captured by the imaging device 300. In some implementations, the first indicia and/or the plurality of payload-encoding indicia are displayed on a mobile device (e.g., the mobile device 350 of FIG. 3A). In further implementations, the first indicia and/or the plurality of payload-encoding indicia are displayed by a computing device and/or other such display, and the imaging device 300 and the mobile device 350 both capture image data of and/or decode the first indicia to initiate a process as described herein.

At block 404, the imaging device 300 decodes the first indicia of the plurality of payload-encoding indicia. In some implementations, the imaging device 300 determines to decode the first indicia responsive to an indication to perform a visual operation. For example, the imaging device 300 detects an indicia in the captured image data, receives an indication of an indicia from a user, etc. In further implementations, the imaging device 300 automatically attempts to perform an indicia decode operation responsive to performing a capture operation as described above. In further implementations, the indicia is or includes a 1D indicia (e.g., a standard barcode) and/or a 2D indicia (e.g., a QR code, 2D watermark, a 2D barcode, and/or any other such 2D indicia as described herein).

At block 406, the imaging device 300 initiates an imaging device connection process. In some implementations, the imaging device 300 initiates the imaging device connection process responsive to decoding the first indicia of the plurality of payload-encoding indicia. In further implementations, the imaging device 300 initiates the imaging device connection process by transmitting an indication to the mobile device 350 to cause the mobile device to display the second indicia of the plurality of payload-encoding indicia. For example, the mobile device may store and/or run an application to assist in pairing an imaging device 300 to the mobile device 350. The imaging device 300 may transmit a message for the application that may cause the application and/or the mobile device 350 to generate a passkey. In further implementations, the application may additionally and/or alternatively intercept and/or otherwise read the generated passkey and generate an encoded indicia (e.g., the second indicia as discussed below) that is representative of the passkey and, when decoded, is the passkey. Depending on the implementation, the mobile device 350 may generate the passkey as a randomly generated sequence of alphanumeric characters, letters, numbers, special characters, etc.

Depending on the implementation, the imaging device connection process is or includes a connection process for a wireless connection protocol (e.g., Bluetooth, Wi-Fi, NFC, etc.). Depending on the implementation, the wireless connection protocol may have multiple levels of security. In such implementations, the imaging device connection process may enable a connection between the imaging device and the mobile device 350 at the highest level of security for the wireless connection protocol.

At block 408, the imaging device 300 captures second image data of a second indicia of the plurality of payload-encoding indicia. In some implementations, the imaging device 300 captures the second image data after initiating the imaging device connection process. In some implementations, the imaging device 300 and/or the mobile device 350 starts a connection timer responsive to initiating the imaging device connection process. The connection timer may be indicative of a period in which a user may input the passkey to perform the imaging device connection process before a timeout occurs, requiring a restart of the process. As such, in further implementations, the connection timer is configured to end the imaging device connection process responsive to expiring. Depending on the implementation, the imaging device 300 may start the connection timer by transmitting a message to a computing device (e.g., the mobile device 350, a communicatively coupled computing device, etc.) that causes the computing device to start the connection timer. Depending on the implementation, the message may be a command to start the timer, a message that has the effect of causing the computing device to start the connection timer, etc. In some implementations, the connection timer is 30 seconds, 60 seconds, 90 seconds, etc. In further implementations, the imaging device 300 and/or a computing device (e.g., the mobile device 350) may deactivate the connection timer responsive to performing the imaging device connection process.

At block 410, the imaging device 300 generates a passkey for performing the imaging device connection process. In some implementations, the imaging device 300 generates the passkey based at least on the second indicia of the plurality of payload-encoding indicia. Depending on the implementation, the passkey may be or include letters, numbers, any alphanumeric characters, special characters, etc.

In some implementations, after generating the passkey, the imaging device 300 automatically transmits the passkey to the mobile device 350. The mobile device 350 may determine whether the passkey matches the key generated by the mobile device 350. If so, the mobile device 350 may transmit a confirmation message to the imaging device 300. The imaging device 300 may perform the imaging device connection process with the mobile device to pair the two devices and enable wireless communication via a given wireless protocol (e.g., Bluetooth, Wi-Fi, NFC, etc.).

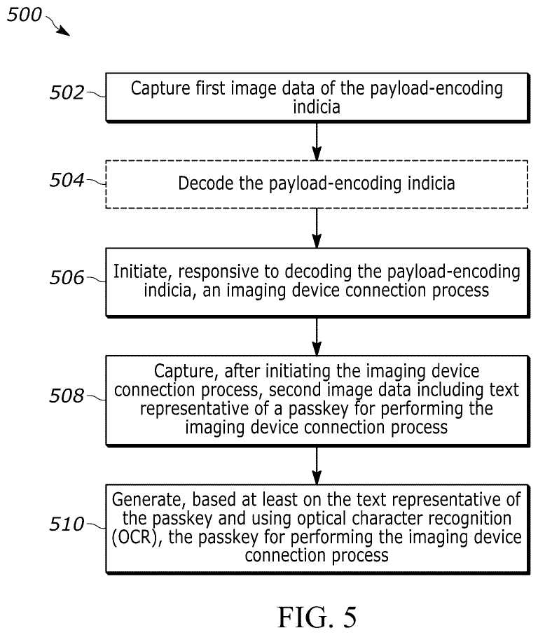

Referring next to FIG. 5, the method 500 illustrates a flow diagram of an example method for performing an optical character recognition (OCR) operation on displayed text (e.g., passcode 358 of FIG. 3B) on a mobile device (e.g., mobile device 350 of FIG. 3B) to connect an imaging device (e.g., imaging device 300) to the mobile device. Although the method 500 is described below with regard to imaging device 300 of FIG. 3B, it will be understood that other similarly suitable imaging devices and/or components may be used instead (e.g., bioptic indicia reader 100, handheld imaging device 150, imaging device 200, etc.).

At block 502, the imaging device 300 captures first image data of a payload-encoding indicia. In some implementations, the payload-encoding indicia is displayed on a mobile device (e.g., the mobile device 350 of FIG. 3A). In further implementations, the payload-encoding indicia is displayed by a computing device and/or other such display, and the imaging device 300 and the mobile device 350 both capture image data of and/or decode the payload-encoding indicia to initiate a process as described herein.

At block 504, the imaging device 300 decodes the payload-encoding indicia. In some implementations, the imaging device 300 determines to decode the indicia responsive to an indication to perform a visual operation. For example, the imaging device 300 detects an indicia in the captured image data, receives an indication of an indicia from a user, etc. In further implementations, the imaging device 300 automatically attempts to perform an indicia decode operation responsive to performing a capture operation as described above. In further implementations, the indicia is or includes a 1D indicia (e.g., a standard barcode) and/or a 2D indicia (e.g., a QR code, 2D watermark, a 2D barcode, and/or any other such 2D indicia as described herein).

At block 506, the imaging device 300 initiates an imaging device connection process. In some implementations, the imaging device 300 initiates the imaging device connection process responsive to decoding the payload-encoding indicia. In further implementations, the imaging device 300 initiates the imaging device connection process by transmitting an indication to the mobile device 350 to cause the mobile device to display the second indicia of the plurality of payload-encoding indicia. For example, the mobile device may store and/or run an application to assist in pairing an imaging device 300 to the mobile device 350. The imaging device 300 may transmit a message for the application that may cause the application and/or the mobile device 350 to generate a passkey. In further implementations, the application may additionally and/or alternatively intercept and/or otherwise read the generated passkey and generate an encoded indicia (e.g., the second indicia as discussed below) that is representative of the passkey and, when decoded, is the passkey. Depending on the implementation, the mobile device 350 may generate the passkey as a randomly generated sequence of alphanumeric characters, letters, numbers, special characters, etc.

Depending on the implementation, the imaging device connection process is or includes a connection process for a wireless connection protocol (e.g., Bluetooth, Wi-Fi, NFC, etc.). Depending on the implementation, the wireless connection protocol may have multiple levels of security. In such implementations, the imaging device connection process may enable a connection between the imaging device 300 and the mobile device 350 at the highest level of security for the wireless connection protocol. In further implementations, the imaging device connection process may enable a connection between the imaging device 300 and the mobile device 350 at another level of security (e.g., a lowest level of security, a middle level of security, etc.).

At block 508, the imaging device 300 captures second image data including text representative of a passkey for performing the imaging device connection process. In some implementations, the imaging device 300 captures the second image data after initiating the imaging device connection process. In some implementations, the imaging device 300 and/or the mobile device 350 starts a connection timer responsive to initiating the imaging device connection process. The connection timer may be indicative of a period in which a user may input the passkey to perform the imaging device connection process before a timeout occurs, requiring a restart of the process. As such, in further implementations, the connection timer is configured to end the imaging device connection process responsive to expiring. Depending on the implementation, the imaging device 300 may start the connection timer by transmitting a message to a computing device (e.g., the mobile device 350, a communicatively coupled computing device, etc.) that causes the computing device to start the connection timer. Depending on the implementation, the message may be a command to start the timer, a message that has the effect of causing the computing device to start the connection timer, etc. In some implementations, the connection timer is 30 seconds, 60 seconds, 90 seconds, etc. In further implementations, the imaging device 300 and/or a computing device (e.g., the mobile device 350) may deactivate the connection timer responsive to performing the imaging device connection process.

At block 510, the imaging device 300 generates, using OCR, the passkey for performing the imaging device connection process. In some implementations, the imaging device 300 generates the passkey based at least on the text representative of the passkey using OCR. Depending on the implementation, the imaging device 300 may perform OCR to recognize one or more characters in the image data (e.g., alphanumeric characters). For example, the mobile device 350 may display a six character passkey (e.g., 123456, ABCDEF, A2C4E6, etc.).

In some implementations, such OCR operations may be or include the conversion of digital text in one or more digital fonts into machine-encoded (and therefore machine-readable) text. In some such implementations, the imaging device 300 and/or a computing device communicatively coupled to the imaging device 300 detects and/or recognizes a digital font in which the digital text is displayed and calls a corresponding OCR program, model, and/or operation accordingly. In further implementations, the imaging device 300 may call and/or otherwise utilize an initial OCR program, model, and/or operation before determining whether the output is accurate (e.g., automatically determining whether any characters have a low confidence score, determining whether any characters could not be read, prompting a user to indicate whether the characters are correct, etc.). If the output is not accurate, the imaging device 300 may utilize alternate OCR programs, models, and/or operations configured to analyze other fonts. In some such implementations, the imaging device 300 analyzes the display according to one or more OCR templates to narrow areas and/or text that the imaging device 300 is to look for and/or analyze using the OCR procedure.

In further implementations, OCR operations may be or include accurately recognizing and interpreting characters from images or documents. The OCR operations may additionally be or include feature extraction (e.g., extraction of features such as edges, corners, and gradients from an input image to represent the characteristics of each character). Depending on the implementation, the OCR algorithm and/or model may perform or utilize histogram of oriented gradients (HOG) techniques, scale-invariant feature transform (SIFT) techniques, or convolutional neural networks (CNNs) for feature and/or text extraction. In some implementations (e.g., where multiple characters are present in an image), the OCR algorithm and/or model may additionally use or perform segmentation techniques to separate individual characters for recognition.

In some implementations, OCR operations may additionally include preprocessing steps such as image enhancement, noise reduction, and binarization to improve the quality of the input image and enhance the clarity of characters. Similarly, the OCR operations may additionally include postprocessing techniques like language modeling, spell checking, and context analysis to improve the accuracy of OCR results and correct errors introduced during the recognition process.

In further implementations, the imaging device 300 may enter an OCR operation mode responsive to detecting that acceleration and/or movement have stopped (e.g., using an internal accelerometer, gyroscope, etc.). In still further implementations, the imaging device 300 enters the OCR operation mode and/or performs the OCR procedure responsive to detecting text and/or a screen/display. In still further implementations, the imaging device 300 enters the OCR operation mode and/or performs the OCR operation responsive to a physical input (e.g., a trigger pull, a button press, etc.). Depending on the implementation, the OCR procedure may be performed at the imaging device 300 and/or transmitted to another computing device for analysis.

Embodiments of the present disclosure may have certain advantages over traditional approaches. For example, using a technique for scanning a first indicia to initiate the connection process and a second indicia for determining the entire passcode may reduce the overall processing and/or computing resources required compared to other potential techniques, such as decoding a plurality of barcodes (e.g., six barcodes) to input the passcode. Similarly, using a technique for scanning an indicia to initiate the connection process and performing an OCR procedure to determine the entire passcode may reduce the overall processing and/or computing resources required. Moreover, by implementing such techniques, an imaging device may be enabled to establish a secure connection with another computing device with fewer timeouts, reducing the number of reestablishment requests are transmitted, thereby further improving overall functionality (e.g., by reducing the processing time and computing resources required).

The following list of aspects reflects a variety of the embodiments explicitly contemplated by the present disclosure:

Aspect 1. An imaging device, comprising: an imaging assembly configured to capture image data of a plurality of payload-encoding indicia, the image data including a field of view (FOV); and a computer-readable media storing machine readable instructions that, when executed, cause the imaging device to: capture, using the imaging assembly, first image data of a first indicia of the plurality of payload-encoding indicia; initiate, responsive to decoding the first indicia of the plurality of payload-encoding indicia, an imaging device connection process; capture, using the imaging assembly and after initiating the imaging device connection process, second image data of a second indicia of the plurality of payload-encoding indicia; and generate, based at least on the second indicia of the plurality of payload-encoding indicia, a passkey for performing the imaging device connection process.

Aspect 2. The imaging device of aspect 1, wherein the imaging device connection process is a wireless pairing process to pair the imaging device to a computing device.

Aspect 3. The imaging device of aspect 2, wherein the computer-readable media stores further machine readable instructions that, when executed, cause the imaging device to: transmit the passkey to the computing device; and perform, after transmitting the passkey to the computing device, the imaging device connection process with the computing device.

Aspect 4. The imaging device of aspect 2, wherein initiating the imaging device connection process includes: transmitting an indication to the computing device to cause the computing device to display the second indicia of the plurality of payload-encoding indicia.

Aspect 5. The imaging device of aspect 4, wherein: the indication includes a message to the computing device to cause an application stored on the computing device to initiate a passkey generation process to generate the passkey; and the second indicia is representative of the passkey.

Aspect 6. The imaging device of aspect 5, wherein the passkey includes a randomly generated sequence of alphanumeric characters.

Aspect 7. The imaging device of aspect 1, wherein the plurality of payload-encoding indicia includes at least one of: (i) a one-dimensional (1D) barcode, (ii) a two-dimensional (2D) barcode, or (iii) a 2D data matrix.

Aspect 8. The imaging device of aspect 1, wherein the computer-readable media stores further machine readable instructions that, when executed, cause the imaging device to: start, responsive to initiating the imaging device connection process, a connection timer configured to end the imaging device connection process responsive to expiring.

Aspect 9. The imaging device of aspect 8, wherein the computer-readable media stores further machine readable instructions that, when executed, cause the imaging device to: deactivate, responsive to performing the imaging device connection process, the connection timer.

Aspect 10. The imaging device of aspect 8, wherein starting the connection timer includes: transmitting, responsive to initiating the imaging device connection process, a message to a computing device to cause the computing device to start the connection timer.

Aspect 11. The imaging device of aspect 1, wherein the imaging device connection process is associated with a wireless connection protocol.

Aspect 12. The imaging device of aspect 11, wherein the imaging device connection process enables a connection between the imaging device and a mobile device at a highest level of security for the wireless connection protocol.

Aspect 13. An imaging device, comprising: an imaging assembly configured to capture image data of a payload-encoding indicia, the image data including a field of view (FOV); and a computer-readable media storing machine readable instructions that, when executed, cause the imaging device to: capture, using the imaging assembly, first image data of the payload-encoding indicia; initiate, responsive to decoding the payload-encoding indicia, an imaging device connection process; capture, using the imaging assembly and after initiating the imaging device connection process, second image data including text representative of a passkey for performing the imaging device connection process; and generate, based at least on the text representative of the passkey and using optical character recognition (OCR), the passkey for performing the imaging device connection process.

Aspect 14. The imaging device of aspect 13, wherein the imaging device connection process is a wireless pairing process to pair the imaging device to a computing device.

Aspect 15. The imaging device of aspect 14, wherein the computer-readable media stores further machine readable instructions that, when executed, cause the imaging device to: transmit the passkey to the computing device; and perform, after transmitting the passkey to the computing device, the imaging device connection process with the computing device.

Aspect 16. The imaging device of aspect 14, wherein initiating the imaging device connection process includes: transmitting an indication to the computing device to cause the computing device to display the text representative of the passkey.

Aspect 17. The imaging device of aspect 13, wherein the text representative of the passkey includes a randomly generated sequence of alphanumeric characters.

Aspect 18. The imaging device of aspect 13, wherein the payload-encoding indicia includes at least one of: (i) a one-dimensional (1D) barcode, (ii) a two-dimensional (2D) barcode, or (iii) a 2D data matrix.

Aspect 19. The imaging device of aspect 13, wherein the computer-readable media stores further machine readable instructions that, when executed, cause the imaging device to: start, responsive to the initiating the imaging device connection process, a connection timer configured to end the imaging device connection process responsive to expiring.

Aspect 20. The imaging device of aspect 19, wherein the computer-readable media stores further machine readable instructions that, when executed, cause the imaging device to: deactivate, responsive to performing the imaging device connection process, the connection timer.

Aspect 21. The imaging device of aspect 19, wherein starting the connection timer includes: transmitting, responsive to initiating the imaging device connection process, a message to a computing device to cause the computing device to start the connection timer.

Aspect 22. The imaging device of aspect 13, wherein the imaging device connection process is associated with a wireless connection protocol.

Aspect 23. The imaging device of aspect 22, wherein the imaging device connection process enables a connection between the imaging device and a mobile device at a highest level of security for the wireless connection protocol.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ...a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging device, comprising:
an imaging assembly configured to capture image data of a plurality of payload-encoding indicia, the image data including a field of view (FOV); and
a computer-readable media storing machine readable instructions that, when executed, cause the imaging device to:
capture, using the imaging assembly, first image data of a first indicia of the plurality of payload-encoding indicia;
initiate, responsive to decoding the first indicia of the plurality of payload-encoding indicia, an imaging device connection process;
capture, using the imaging assembly and after initiating the imaging device connection process, second image data of a second indicia of the plurality of payload-encoding indicia; and
generate, based at least on the second indicia of the plurality of payload-encoding indicia, a passkey for performing the imaging device connection process.

2. The imaging device of claim 1, wherein the imaging device connection process is a wireless pairing process to pair the imaging device to a computing device.

3. The imaging device of claim 2, wherein the computer-readable media stores further machine readable instructions that, when executed, cause the imaging device to:
transmit the passkey to the computing device; and
perform, after transmitting the passkey to the computing device, the imaging device connection process with the computing device.

4. The imaging device of claim 2, wherein initiating the imaging device connection process includes:
transmitting an indication to the computing device to cause the computing device to display the second indicia of the plurality of payload-encoding indicia.

5. The imaging device of claim 4, wherein:
the indication includes a message to the computing device to cause an application stored on the computing device to initiate a passkey generation process to generate the passkey; and
the second indicia is representative of the passkey.

6. The imaging device of claim 5, wherein the passkey includes a randomly generated sequence of alphanumeric characters.

7. The imaging device of claim 1, wherein the plurality of payload-encoding indicia includes at least one of: (i) a one-dimensional (1D) barcode, (ii) a two-dimensional (2D) barcode, or (iii) a 2D data matrix.

8. The imaging device of claim 1, wherein the computer-readable media stores further machine readable instructions that, when executed, cause the imaging device to:
start, responsive to initiating the imaging device connection process, a connection timer configured to end the imaging device connection process responsive to expiring.

9. The imaging device of claim 8, wherein the computer-readable media stores further machine readable instructions that, when executed, cause the imaging device to:
deactivate, responsive to performing the imaging device connection process, the connection timer.

10. The imaging device of claim 8, wherein starting the connection timer includes:
transmitting, responsive to initiating the imaging device connection process, a message to a computing device to cause the computing device to start the connection timer.

11. The imaging device of claim 1, wherein the imaging device connection process is associated with a wireless connection protocol.

12. The imaging device of claim 11, wherein the imaging device connection process enables a connection between the imaging device and a mobile device at a highest level of security for the wireless connection protocol.

13. An imaging device, comprising:
an imaging assembly configured to capture image data of a payload-encoding indicia, the image data including a field of view (FOV); and
a computer-readable media storing machine readable instructions that, when executed, cause the imaging device to:
capture, using the imaging assembly, first image data of the payload-encoding indicia;
initiate, responsive to decoding the payload-encoding indicia, an imaging device connection process;
capture, using the imaging assembly and after initiating the imaging device connection process, second image data including text representative of a passkey for performing the imaging device connection process; and
generate, based at least on the text representative of the passkey and using optical character recognition (OCR), the passkey for performing the imaging device connection process.

14. The imaging device of claim 13, wherein the imaging device connection process is a wireless pairing process to pair the imaging device to a computing device.

15. The imaging device of claim 14, wherein the computer-readable media stores further machine readable instructions that, when executed, cause the imaging device to:
transmit the passkey to the computing device; and
perform, after transmitting the passkey to the computing device, the imaging device connection process with the computing device.

16. The imaging device of claim 14, wherein initiating the imaging device connection process includes:
transmitting an indication to the computing device to cause the computing device to display the text representative of the passkey.

17. The imaging device of claim 13, wherein the text representative of the passkey includes a randomly generated sequence of alphanumeric characters.

18. The imaging device of claim 13, wherein the payload-encoding indicia includes at least one of: (i) a one-dimensional (1D) barcode, (ii) a two-dimensional (2D) barcode, or (iii) a 2D data matrix.

19. The imaging device of claim 13, wherein the computer-readable media stores further machine readable instructions that, when executed, cause the imaging device to:
start, responsive to the initiating the imaging device connection process, a connection timer configured to end the imaging device connection process responsive to expiring.

20. The imaging device of claim 19, wherein the computer-readable media stores further machine readable instructions that, when executed, cause the imaging device to:
deactivate, responsive to performing the imaging device connection process, the connection timer.

21. The imaging device of claim 19, wherein starting the connection timer includes:
transmitting, responsive to initiating the imaging device connection process, a message to a computing device to cause the computing device to start the connection timer.

22. The imaging device of claim 13, wherein the imaging device connection process is associated with a wireless connection protocol.

23. The imaging device of claim 22, wherein the imaging device connection process enables a connection between the imaging device and a mobile device at a highest level of security for the wireless connection protocol.
